(19) United States
(12) Patent Application Publication
(10) Pub. No.: US 2026/0093422 A1
(43) Pub. Date: Apr. 2, 2026

(54) JOB TICKET MAPPING MECHANISM

(71) Applicants: Gerald D. Boldt, Boulder, CO (US); Cristina Dogaru, Timisoara (RO)

(72) Inventors: Gerald D. Boldt, Boulder, CO (US); Cristina Dogaru, Timisoara (RO)

(73) Assignee: Ricoh Company, Ltd., Tokyo (JP)

(21) Appl. No.: 18/903,881

(22) Filed: Oct. 1, 2024

(51) Int. Cl. G06F 3/12

(52) U.S. Cl. CPC G06F 3/1206; G06F 3/121; G06F 3/1234; G06F 3/1247; G06F 3/1275

(57) ABSTRACT

A system to is described. The system includes at least one physical memory device to store print workflow manager and one or more processors coupled with the at least one physical memory devices to execute the print workflow manager to receive a print job, receive a job ticket including first attributes. determine a mapping between the first attributes in the job ticket and second attributes in a target protocol and convert the first attributes into the second attributes in the job ticket based on the mapping.

### FIELD

This invention relates generally to the field of print services. More particularly, the invention relates to processing print jobs.

### BACKGROUND

Entities with substantial printing demands typically implement a high-speed production printer for volume printing (e.g., one hundred pages per minute or more). Production printers may include continuous-forms printers that print on a web of print media (e.g., paper) stored on a large roll. A production printer typically includes a localized print controller that controls the overall operation of the printing system, and a print engine that includes one or more printhead assemblies, where each assembly includes a printhead controller and a printhead (or array of printheads).

### SUMMARY

In one embodiment, a system is disclosed. The system includes at least one physical memory device to store print workflow manager and one or more processors coupled with the at least one physical memory devices to receive a print job, receive a job ticket including first attributes. determine a mapping between the first attributes in the job ticket and second attributes in a target protocol and convert the first attributes into the second attributes in the job ticket based on the mapping.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates one embodiment of a system having a computing device employing a workflow manager.

FIG. 2 illustrates one embodiment of a workflow manager.

FIG. 3 is a flow diagram illustrating one embodiment of a method for performing a print workflow.

FIG. 4 illustrates one embodiment of a printing system.

FIGS. 5A & 5B illustrate one embodiment of job attribute mapping.

FIG. 6 is a flow diagram illustrating one embodiment of a process for mapping job settings.

FIG. 7 illustrates a computing device suitable for implementing embodiments of the present disclosure.

### DETAILED DESCRIPTION

Job Definition Format (JDF) is the communication of choice for managing print production workflows between production printers, inserters, folders, cutters, and printing software. One advantage of JDF is the ability to define plex (e.g., duplex or simplex) settings for printing at the page level. This is important in cutsheet printers because the plex level JDF settings enables construction of Portable Document Format (PDF) files that do not require blank backs to be inserted to ensure the output of a printed PDF is correct, resulting in more expensive printing since blank backs cost customers extra click charges.

JDF job tickets are implemented to indicate desired attributes for print jobs. However, the majority of printers are not capable of directly handling job attributes described in JDF. Thus, the attributes reported in JDF job tickets are often converted to another protocol (e.g., target protocol) that is supported by the printer that will print the job. These converted job attributes are subsequently forwarded to the printer. However, the conversion of job attributes to a different format is a notably difficult process because there is not a one-to-one correspondence between protocols for many job attributes. For example, job attributes may map from many-to-few, or may not map at all. As a result, the conversion process is subject to ambiguity that a protocol conversion system attempts to address by inferring the existence (or non-existence) of job attributes.

In some cases, the conversion is performed without error. However, in other cases, the combination of job attributes chosen by a protocol conversion system is not supported by the printer. Thus, print shop operators continue to strive for more efficient techniques for ensuring that JDF job attributes are automatically converted into formats suitable for their printers.

According to one embodiment, a mapping mechanism is provided to convert a set of print production attributes received in a print protocol included in a job ticket to attributes and/or commands of a target print protocol implemented by a target system. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Throughout this document, terms like “logic”, “component”, “module”, “engine”, “model”, “interface”, and the like, may be referenced interchangeably and include, by way of example, software, hardware, and/or any combination of software and hardware, such as firmware. Further, any use of a particular brand, word, term, phrase, name, and/or acronym, should not be read to limit embodiments to software or devices that carry that label in products or in literature external to this document.

It is contemplated that any number and type of components may be added to and/or removed to facilitate various embodiments including adding, removing, and/or enhancing certain features. For brevity, clarity, and ease of understanding, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

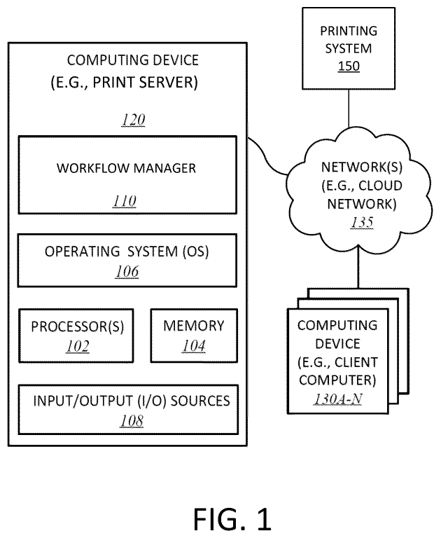

FIG. 1 illustrates a system 100 having a computing device 120 employing a workflow manager 110. In such an embodiment, computing device 120 includes a print server computer serving as a host machine for employing workflow manager 110 to manage print workflows received from one or more computing devices 130 for printing at printing system 150.

In one embodiment, computing device 120 includes an operating system (“OS”) 106 serving as an interface between one or more hardware/physical resources of computing device 120, one or more client devices 130 (e.g., 130A-130N) and a printing system 150 via a network 135. In other embodiments, network 135 may be implemented as local area network (LAN). Computing device 120 further includes processor(s) 102, memory 104, input/output (“I/O”) sources 108, such as touchscreens, touch panels, touch pads, virtual or regular keyboards, virtual or regular mice, etc.

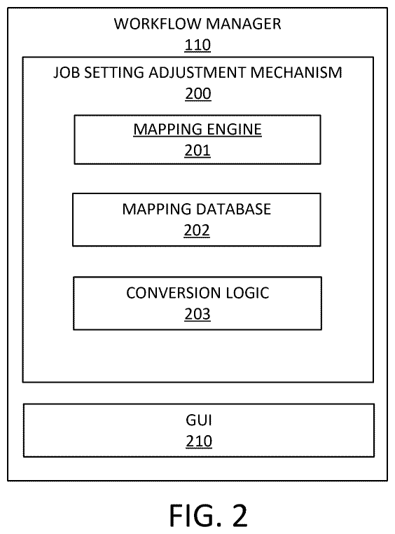

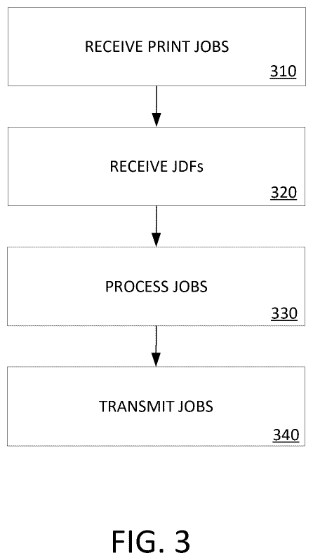

FIG. 2 illustrates one embodiment of workflow manager 110 to perform a print workflow, while FIG. 3 is a flow diagram illustrating an embodiment of a process for performing a print workflow. At processing block 310, a print file including one or more print jobs (e.g., in a PDF format) is received. At processing block 320, job tickets are received to describe how the print jobs are to be printed. In one embodiment, the job ticket is a JDF ticket. In other embodiments, job tickets may be generated at workflow manager 110. At processing block 330, the print jobs are processed. In one embodiment, the processing includes job ticket processing and performing a conversion of JDF attributes in the job ticket to attributes and commands in a format supported at printing system 150, as will be discussed in detail below. At processing block 340, the jobs are transmitted to printing system 150 for printing.

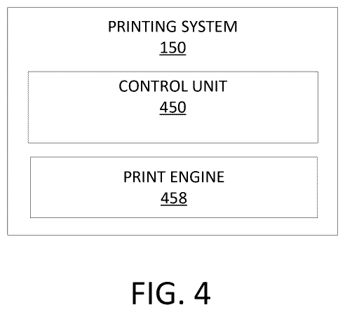

FIG. 4 illustrates one embodiment of such a printing system 150. Printing system 150 includes a control unit 450 and a print engine 458. According to one embodiment, control unit 450 processes and renders objects received in print job data and provides sheet maps for printing to print engine 458. Control unit (e.g., DFE or digital front end) 450 is implemented to process image objects received at control unit 450 by a raster image processor (RIP) to convert an image described in a vector graphics format (e.g., shapes) into a raster image (e.g., pixels) that is to be stored as scan line data in a memory array (not shown) for output to print engine 458.

Referring back to FIG. 2, workflow manager 110 includes a job setting adjustment mechanism (or adjustment mechanism) 200 that is implemented in the workflow to convert print attributes. According to one embodiment, adjustment mechanism 200 includes mapping engine 201, mapping database 202 and conversion logic 203.

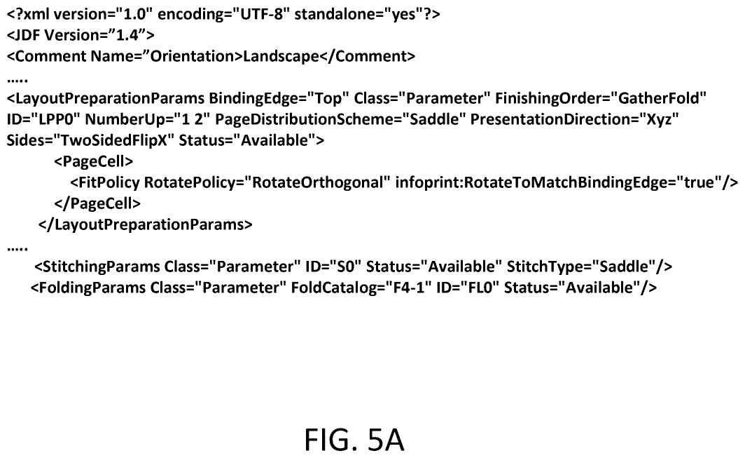

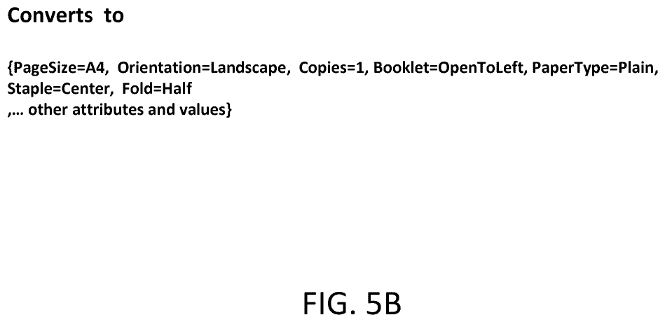

As discussed above, workflow manager 110 receives a print job to be printed at printing system 150, as well as a generated job ticket. Mapping engine 201 performs a mapping between attributes in the job ticket and attributes in a target protocol (e.g., printer format) language. In one embodiment, mapping engine 201 performs one or more mappings by examining a list of job attributes and values in a job ticket to determine one or more functions indicated by the attributes/values that are to be performed. In this embodiment, mapping engine 201 processes the job ticket to identify each set of attributes/values that represent a function. For example, mapping engine 201 may identify a first set of attributes/values in the job ticket that represent a first function (e.g., generating a booklet open to left with 2 staple at center) and a second set of attributes/values in the job ticket that represent a second function. FIG. 5A illustrates one embodiment of JDF attribute/values in a received job ticket.

Once the function to be performed is determined, mapping engine 201 queries (or searches) mapping database 202 using an identified function to determine a set of attributes/values in the target protocol that perform the function. Thus, mapping database 202 includes a list of attribute/value sets in the target protocol associated with each of a plurality of functions that are performed. In one embodiment, mapping database 202 is generated during a development and test phase that is performed some time prior to print processing. In such an embodiment, the database mappings are generated by generating a JDF for supported functions and harvesting attribute value pairs of interest for each function. Subsequently, the attribute value pairs are used to populate mapping database 202. In an alternative embodiment, JDF specifications are implemented to list attributes and values for each function. In this embodiment, function attributes and values are tested to confirm that the mappings are correctly invoked and the desired function is accomplished on the printer.

Mapping engine 201 selects the target protocol set of attributes/values that match an identified function to be used to print the job. In some embodiments, mapping database 202 may not include attributes/values that map to a function indicated by the set of attributes/values in the job ticket. In such an embodiment, mapping engine 201 generates an error message indicating that a mapping has not been found for the job ticket function. In a further embodiment, mapping engine 201 may facilitate the display of a message at a graphical user interface (GUI) 210 requesting input and/or intervention by a print shop operator.

Conversion logic 203 performs a conversion of the job ticket attributes/values to the corresponding attributes/values found in mapping database 202. In one embodiment, conversion logic 203 converts attributes included in the job ticket into job attributes of a format supported by printing system 150, such Postscript, Fiery, Kodak KDK, Xerox XRX, etc. Conversion logic 203 may perform job attribute conversions immediately before printing, or as soon as a final job ticket has been received for a print job. In a further embodiment, conversion logic 203 performs the conversion by accessing mapping database 202 and replacing job ticket attributes with corresponding attributes in the target format for each function in the job ticket and inserting the target format attributes into a file to be transmitted to the target [JERRY: IS THIS CORRECT?]. FIG. 5B illustrates one embodiment of converted attribute/values in the target protocol.

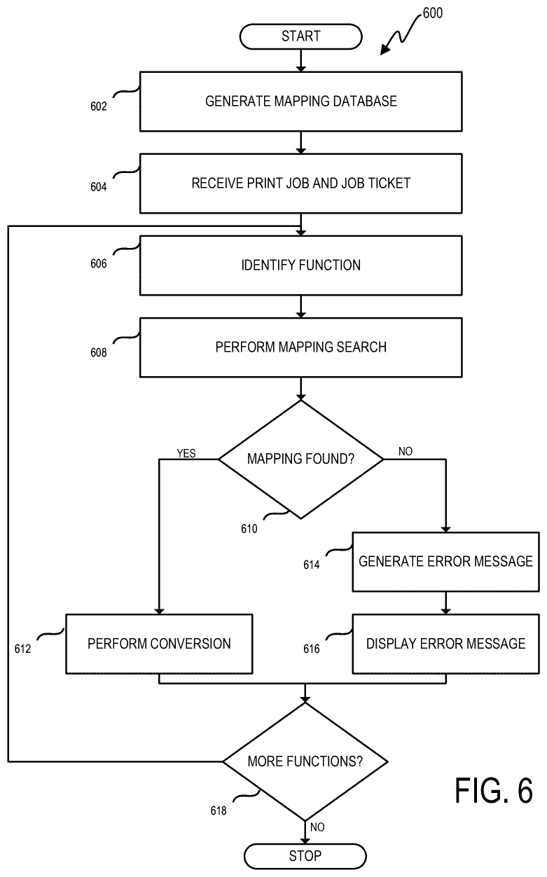

In one embodiment, the print job (e.g., including the converted job attributes) is transmitted to the printer for printing after the mapping and conversion has been performed. FIG. 6 is a flow diagram illustrating one embodiment of a process 600 for mapping job settings. Process 600 may be performed by processing logic that may comprise hardware (e.g., circuitry, dedicated logic, programmable logic, etc.), software (such as instructions run on a processing device), or a combination thereof. In one embodiment, process 600 may be performed by adjustment mechanism 200. The process 600 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-5 are not discussed or repeated here.

Process 600 begins at processing block 602, where a mapping database is generated. In embodiments, the mapping database is generated during a development and test phase. At processing block 604, a print job and job ticket may be received once the development and test phase has been completed. At processing block 606, a function is identified within the job ticket. As discussed above, a function is identified based on a set of attributes/values in the job ticket that represent the first function. At processing block 608, a search of the mapping database is performed.

At decision block 610, a determination is made as to whether the mapping database includes a mapping of the job ticket function to a corresponding function in a target protocol. In another embodiment, processing blocks 606 and 608 may be reversed such that the mapping database may be accessed to retrieve a function and the job ticket is searched. Thus, decision block 610 would determine whether the job ticket includes attributes associated with the function.

A conversion is performed, at processing block 612, upon a determination that a mapping has been found. Otherwise, an error message is generated indicating that no mapping has been found, processing block 614. At processing block 616, the error message is transmitted (e.g., to GUI 210). In an alternative embodiment, no error message is generated in instances in which no mapping has been found. In such an embodiment, a function for which no mapping for a target protocol has been found is printed. However, the data is printed without the formatting indicated by the function in the job ticket.

At decision block 618, a determination is made as to whether the job ticket includes additional functions that are to be mapped. If so, control is returned to processing block 606 where the next function is identified and processed as discussed above. Otherwise, process 600 has completed. In the database access embodiment discussed above, the determination made at decision block 618 is whether the mapping database includes additional functions.

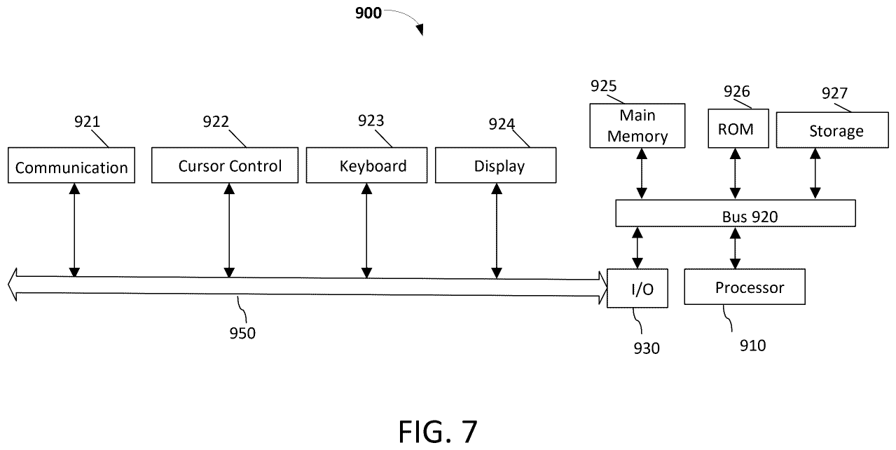

FIG. 7 illustrates a computer system 900 on which computing device 120 may be implemented. Computer system 900 includes a system bus 920 for communicating information, and a processor 910 coupled to bus 920 for processing information.

Computer system 900 further comprises a random-access memory (RAM) or other dynamic storage device 925 (referred to herein as main memory), coupled to bus 920 for storing information and instructions to be executed by processor 910. Main memory 925 also may be used for storing temporary variables or other intermediate information during execution of instructions by processor 910. Computer system 900 also may include a read only memory (ROM) and or other static storage device 926 coupled to bus 920 for storing static information and instructions used by processor 910.

A data storage device 927 such as a magnetic disk or optical disc and its corresponding drive may also be coupled to computer system 900 for storing information and instructions. Computer system 900 can also be coupled to a second I/O bus 950 via an I/O interface 930. A plurality of I/O devices may be coupled to I/O bus 950, including a display device 924, an input device (e.g., a keyboard (or alphanumeric input device) 923 and or a cursor control device 922). The communication device 921 is for accessing other computers (servers or clients). The communication device 921 may comprise a modem, a network interface card, or other well-known interface device, such as those used for coupling to Ethernet, token ring, or other types of networks.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A system comprising:
at least one physical memory device to store a print workflow manager; and
one or more processors coupled with the at least one physical memory device to execute the print workflow manager to:
receive a print job;
receive a job ticket including first attributes;
determine a mapping between the first attributes in the job ticket and second attributes in a target protocol; and
convert the first attributes into the second attributes in the job ticket based on the mapping.

2. The system of claim 1, wherein determining the mapping comprises examining a list of job attributes and values in the job ticket to determine one more functions to be performed.

3. The system of claim 2, wherein determining the mapping further comprises identifying a first function to be performed represented by the first attributes.

4. The system of claim 3, wherein determining the mapping further comprises searching a mapping database using the first function and determining whether the mapping database includes the mapping of the first function to a corresponding function in the target protocol.

5. The system of claim 4, wherein the print workflow manager further to select the second attributes upon a determination that the first function corresponds to a function in the target protocol.

6. The system of claim 4, wherein the print workflow manager further to generate an error message indicating that the mapping has not been found upon a determination that the first function does not correspond to a function in the target protocol.

7. The system of claim 4, wherein the print workflow manager further to generate the mapping database.

8. The system of claim 4, wherein the mapping database comprises a list of attribute sets in the target protocol associated with each of a plurality of functions in the job ticket.

9. The system of claim 1, further comprising a printer to receive the second attributes.

10. The system of claim 1, wherein the job ticket comprises a Job Definition Format (JDF) job ticket and the target protocol comprises a printer format language.

11. A computer-readable medium having stored thereon instructions that, when executed by one or more processors, cause the one or more processors to:
receive a print job;
receive a job ticket including first attributes;
determine a mapping between the first attributes in the job ticket and second attributes in a target protocol; and
convert the first attributes into the second attributes in the job ticket based on the mapping.

12. The computer-readable medium of claim 11, wherein determining the mapping comprises examining a list of job attributes and values in the job ticket to determine one more functions to be performed.

13. The computer-readable medium of claim 12, wherein determining the mapping further comprises identifying a first function to be performed represented by the first attributes.

14. The computer-readable medium of claim 13, wherein determining the mapping further comprises searching a mapping database using the first function and determining whether the mapping database includes the mapping of the first function to a corresponding function in the target protocol.

15. The computer-readable medium of claim 14, having stored thereon instructions that, when executed by one or more processors, cause the one or more processors further to select the second attributes upon a determination that the first function corresponds to a function in the target protocol.

16. A method comprising:
receiving a print job;
receiving a job ticket including first attributes;
determining a mapping between the first attributes in the job ticket and second attributes in a target protocol; and
converting the first attributes into the second attributes in the job ticket based on the mapping.

17. The method of claim 16, wherein determining the mapping comprises examining a list of job attributes and values in the job ticket to determine one more functions to be performed.

18. The method of claim 17, wherein determining the mapping further comprises identifying a first function to be performed represented by the first attributes.

19. The method of claim 18, wherein determining the mapping further comprises searching a mapping database using the first function and determining whether the mapping database includes the mapping of the first function to a corresponding function in the target protocol.

20. The method of claim 19, further comprising selecting the second attributes upon a determination that the first function corresponds to a function in the target protocol.
